(19) United States
(12) Patent Application Publication
(10) Pub. No.: US 2005/0269935 A1
(43) Pub. Date: Dec. 8, 2005

(54) Surface light source device and back light unit having the same

(75) Inventors: Geun-Young Kim, Seoul (KR); Ki-Yeon Lee, Suwon-si (KR); Seog-Hyun Cho, Seoul (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/142,354

(22) Filed: Jun. 2, 2005

(30) Foreign Application Priority Data
Jun. 3, 2004 (KR) 10-2004-40194

(51) Int. Cl. H01J 1/62

(52) U.S. Cl. 313/493

(57) ABSTRACT

In a surface light source capable of uniformizing a luminance, a body includes a plurality of partition walls, and a gas passage. The partition walls divide an inner space that has a discharge gas into a plurality of discharge spaces that are isolated from each other. The gas passage is formed on each of the partition walls to provide a discharge gas to each of the discharge spaces. The gas passage is formed to be inclined with respect to a lengthwise direction of the discharge space. An electrode that is disposed on the body supplies the discharge voltage to the discharge gas.

### CROSS-REFERENCE TO RELATED APPLICATIONS

This application claims priority under 35 USC § 119 to Korean Patent Application No. 2004-0040194, filed on Jun. 03, 2004, the contents of which are herein incorporated by reference in its entirety.

### BACKGROUND OF THE INVENTION

1. Field of the Invention

The present invention relates to a surface light source device and back light unit having the same. More particularly, the present invention relates to a surface light source device that has a partition wall for forming discharge spaces and a back light unit having the surface light source device.

2. Description of the Related Art

Generally, a liquid crystal using a liquid crystal display (LCD) apparatus has electrical and optical characteristics. In the LCD apparatus, the arrangement of the liquid crystal may vary in response to a direction of an electric field applied thereto, and a light transmittance thereof may be changed in accordance with the arrangement thereof.

The LCD apparatus displays the image using electric characteristics and optical characteristics of the liquid crystal. The LCD apparatus is smaller and lighter than a cathode ray tube (CRT) type display device. Thus, the LCD apparatus is widly used in various electronic apparatus, for example, such as a portable computer, communication equipment, a liquid crystal television receiver set, an aerospace device, etc.

To display an image, the LCD apparatus includes a liquid crystal controlling part for controlling the liquid crystal and a light supplying part for supplying a light to the light controlling part. The liquid crystal controlling part includes a pixel electrode disposed on a first substrate, a common electrode positioned at a second substrate corresponding to the first substrate, and the liquid crystal interposed between the pixel electrode and the common electrode. The liquid crystal controlling part includes a plurality of the pixel electrodes corresponding to a resolution, and the common electrode is disposed at a position corresponding to the pixel electrodes. A plurality of thin film transistors (TFTs) is electrically connected to the pixel electrode to supply a pixel voltage having a different level from one another to the pixel electrode, respectively. A reference voltage is applied to the common electrode. The pixel electrode and the common electrode may include a transparent conductive material.

The light supplying part supplies the liquid crystal of the liquid crystal controlling part with the light. The light successively passes through the pixel electrode, the liquid crystal and the common electrode. A display quality of an image that has passed through the liquid crystal is influenced by a luminance and a uniformity of the luminance of the light that is generated from the light supplying part. When the luminance and the uniformity of the luminance of the light increase, the display quality of the LCD apparatus also increases in proportion to the luminance and the uniformity of the luminance of the light.

The light supplying part of the conventional LCD apparatus includes a cold cathode fluorescent lamp (CCFL) having a bar shape or a light emitting diode (LED) having a dot shape. The CCFL has various characteristics, for example, such as high luminance, long lifetime, and small heat value in comparison with an incandescent lamp, etc. Therefore, the LED has various characteristics, for example, high luminance and so on. However, The CCFL and the LED have non-uniform luminance.

Therefore, the light supplying part having a light source such as the CCFL or LED includes an optical member, for example, such as a light guide panel (LGP), a diffusion member, and a prism sheet, etc. so as to enhance the uniformity of the luminance of the light that is generated from the light supplying part. Thus, a dimension such as a volume and a weight of the LCD apparatus having the CCFL or the LED is increased in proportion to a dimension of the optical member.

In recent years, a surface light source having a flat shape has been developed so as to solve the above problem.

FIG. 1 is a plan view illustrating a conventional surface light source device.

Referring to FIG. 1, a conventional surface light source includes a body 1 and electrodes 4 disposed on both outer faces of the body 1. The body 1 includes the first and second substrates (not shown) opposite to each other. The first and second substrates are spaced apart from each other by a predetermined interval. A plurality of partition walls 2 are interposed between the first and second substrates to divide a space formed between the first and second substrates into a plurality of discharge spaces 5. A sealing member 3 is formed between peripheral portions of the first and second substrates to isolate the discharge spaces 5 from an external portion of the body 1. A discharge gas for generating the light is provided to each of the discharge spaces 5.

The partition walls 2 are alternately disposed between the first and second substrates to form the discharge space 5 in a serpentine structure. Thus, a passage of the discharge gas is formed between an end portion of the partition wall 2 and an inner wall of the sealing member 3 corresponding to the end portion thereof.

FIG. 2 is a plan view illustrating a conventional surface light source in accordance with another example.

Referring to FIG. 2, a surface light source includes a body 11 and an electrode 14. The body 11 includes partition walls 12 and a sealing member 13. The body 11 has a plurality of discharge spaces 15 that are formed by arranging the partition walls 12 in a space of the body 11. Both end portions of the partition walls 12 make contact with an inner surface of the sealing member 13. A passage 16 through which the discharge gas flows into each of the discharge saces 15 is formed through the partition wall 12. In particular, the passage 16 is formed along in a direction substantially perpendicular to a length direction of the partition wall 12.

Meanwhile, to improve luminance of the surface light source, a current drift effect is suppressed. When a potential difference is generated between adjacent discharge spaces, a current in a discharge space in which a relatively high voltage is generated is drifted into another discharge space in which a relatively low voltage is generated. This phenomenon is referred to as the current drift effect. The current drift effect lowers the luminance uniformity. Thus, the current is rapidly moved through the passage.

However, in the conventional light surface source, the direction of the passage is substantially perpendicular to a length direction of the discharge space so that the current drift effect is excessively generated.

### SUMMARY OF THE INVENTION

Embodiments of the present invention provide a surface light source device that has improved luminance by suppressing a current drift effect.

Embodiments of the present invention provide a back light unit that includes above mentioned the surface light source.

In accordance one aspect of the present invention, a surface light source includes a body having an inner space into which a discharge gas is injected, and an D electrode for applying a voltage to the discharge gas. The body includes a plurality of partition walls, and gas passages. The partition walls divide the inner space into a plurality of discharge spaces that are isolated from each other. The gas passages through which the discharge gas passes are formed through the partition walls in an inclined direction with respect to a length direction of the discharge space, respectively.

According to one embodiment, the body includes a first substrate, a second substrate disposed over the first substrate, and a sealing member that is interposed between edges of the first and second substrates. The sealing member defines the inner space of the body. The partition walls make contact with an inner wall of the sealing member.

According to another embodiment, the body includes a first substrate and a second substrate positioned over the first substrate. The partition walls are integrally formed with the second substrate. The partition walls make contact with the first substrate.

According to the still another embodiment, the body includes a first substrate formed integrally with the partition walls, and a second substrate arrayed over the first substrate. The partition walls make contact with the second substrate.

According to the yet still another embodiment, the body includes a first substrate with which first partition wall portions are integrally formed, and a second substrate with which second partition wall portions are integrally formed. The first and second partition wall portions make contact with each other.

A back light unit in accordance with another aspect of the present invention includes a surface light source device, a case receiving the surface light source device, an optical sheet interposed between the surface light source device and the case, and an inverter applying a discharge voltage to the surface light source device. The surface light source device includes a body having an inner space into which a discharge gas is injected, and an electrode for applying a voltage to the discharge gas. The body includes a plurality of partition walls, and gas passages. The partition walls divide the inner space into a plurality of discharge spaces that are isolated from each other. The gas passages through which the discharge gas passes are formed through each of the partition walls in an inclined direction with respect to a length direction of the discharge space.

According to the present invention, the gas passage is inclined with respect to the lengthl direction of the partition walls so that a current drift effect may be suppressed. As a result, the surface light source device may have improved luminance.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a plan view illustrating a conventional surface light source device;

FIG. 2 is a plan view illustrating a conventional surface light source device;

FIG. 3 is a plan view illustrating a surface light source device in accorddance with a first embodiment of the present invention;

FIG. 4 is an enlarged perspective view illustrating a portion ‘IV’ in FIG. 3;

FIG. 5 is a plan view illustrating a surface light source device including gas passages that are arrayed in a zigzag pattern;

FIG. 6 is a plan view illustrating a surface light source device including gas passages that have S shapes;

FIG. 7 is a perspective view illustrating a surface light source device in accordance with a second embodiment of the present invention;

FIG. 8 is an enlarged perspective view illustrating a portion ‘VII’ in FIG. 8;

FIG. 9 is a perspective view illustrating a surface light source device including gas passages that are arrayed in a zigzag pattern;

FIG. 10 is a perspective view illustrating a surface light source device including gas passages that have S shapes;

FIG. 11 is a perspective view illustrating a surface light source device in accordance with a third embodiment of the present invention;

FIG. 12 is a perspective view illustrating a surface light source device in accordance with four embodiment of the present invention; and

FIG. 13 is an exploded perspective view illustrating a back light unit having the surface light source device in accordance with a fourth embodiment of the present invention.

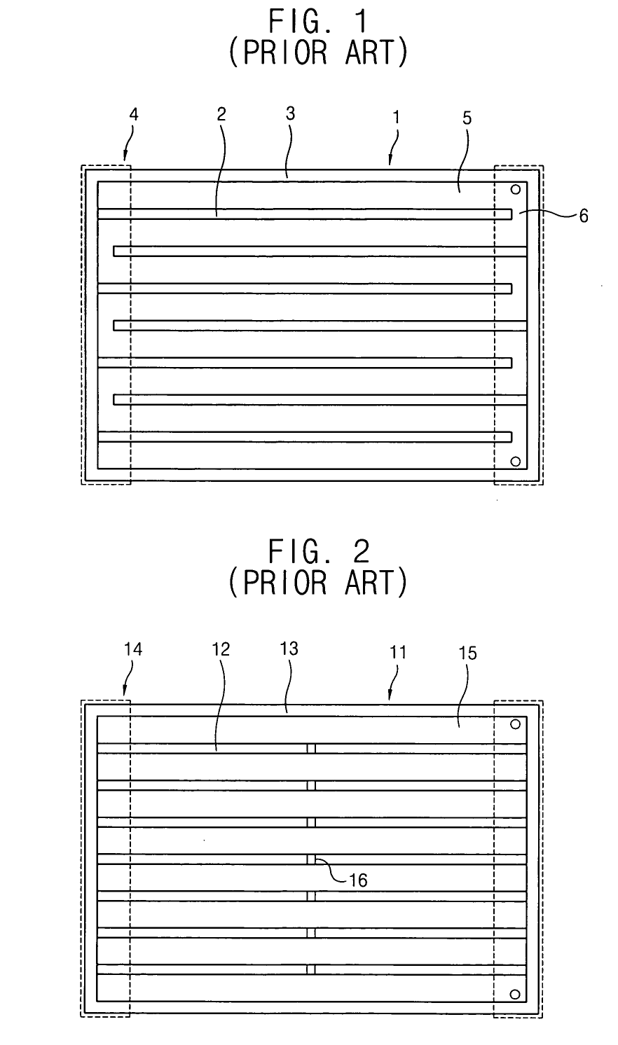

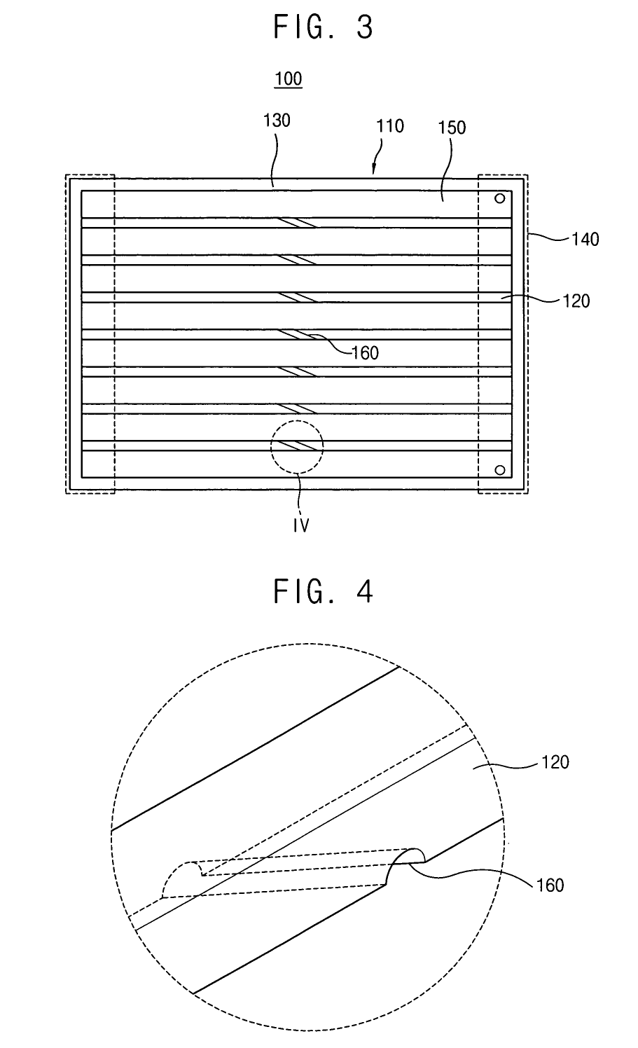

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Embodiment 1

FIG. 3 is a plan view illustrating a surface light source device in accordance with a first embodiment of the present invention. FIG. 4 is an enlarged perspective view illustrating a portion ‘IV’ in FIG. 3.

Referring to FIGS. 3 and 4, a surface light source device 100 in accordance with the present embodiment includes a body 110 having an inner space into which a discharge gas is injected, and an electrode 140 supplying a discharge voltage to the discharge gas. Examples of the discharge gas include a mercury gas, an argon gas, a neon gas, a xenon gas, etc. These can be used alone or in a combination thereof.

The body 110 includes a first substrate (not shown), a second substrate (not shown) disposed over the first substrate, a sealing member 130 disposed between edges of the first and second substrates, and a plurality of partition walls 120 that are arrayed between the first and second substrates to divide the inner space into a plurality of discharge spaces 150. Additionally, the body 110 may include a fluorescent layer (not shown) and a light reflection layer (not shown).

The first and second substrates, for example, have a rectangular flat plate shape. The first and second substrates include a glass material that allows to transmit a visible ray and to block an invisible ray such as an ultraviolet ray. Meanwhile, the partition walls 120 make contact with the first and second substrates. The sealing member 130 is attached to the first and second substrates via a frit.

The partition walls 120 are arrayed substantially in parallel with one another and are spaced apart from each other by substantially identical intervals so that the discharge spaces 150 have long rectangular parallelepiped shapes. Both end portions of the partition walls 120 make contact with an inner face of the sealing member 130. Thus, the discharge spaces 150 are isolated from each other. In this embodiment, each of the partition walls, for example, has a width of about 1 mm to about 5 mm, preferably about 3 mm to about 5 mm.

To provide each of the discharge spaces 150 with a discharge gas, gas passages 160 having a straight shape are formed through center portions of the partition walls 120. The gas passages 160 are inclined with respect to a length direction of the discharge spaces 150. The gas passage 160 serves as to increase a length of a path that is connected to the adjacent two discharge spaces 150. In this embodiment, the gas passage 160 is inclined by an angle of about 40 degrees to about 50 degrees with respect to the length direction of the discharge spaces 150. For example, an inclined angle of the gas passages 160 may be an acute angle relative to the length direction of the partition walls 120. Thus, the gas passages 160 have lengths longer than widths of the partition walls 120.

The electrode 140 includes a conductive material having good conductivity, for example, such as copper (Cu), nickel (Ni), silver (Ag), gold (Au), aluminum (Al), chromium (Cr), etc. The electrode 140 may include a conductive tape that is attached to an outer face of the body 110 or a coating layer including a metal powder that is coated on the outer face of the body 110.

When the voltage is applied to the discharge gas in the discharge space 150 from the electrode 140, currents flow along the length direction of the discharge spaces 150. Here, for example, when a potential difference is formed between the adjacent two discharge spaces 150, the current formed in a discharge space having a relative high electric potential flows into an adjacent discharge space having a relatively low electric potential through the gas passages 160. However, since the gas passages 160 are inclined by the predetermined angle with respect to the length direction of the discharge spaces 150, the current flowing along the lenght direction of the discharge spaces 150 does not rapidly flow through the inclined gas passage 160 to the adjacent discharge space 150. As a result, a current drift effect may be suppressed so that the surface light source device may have enhanced luminance uniformity.

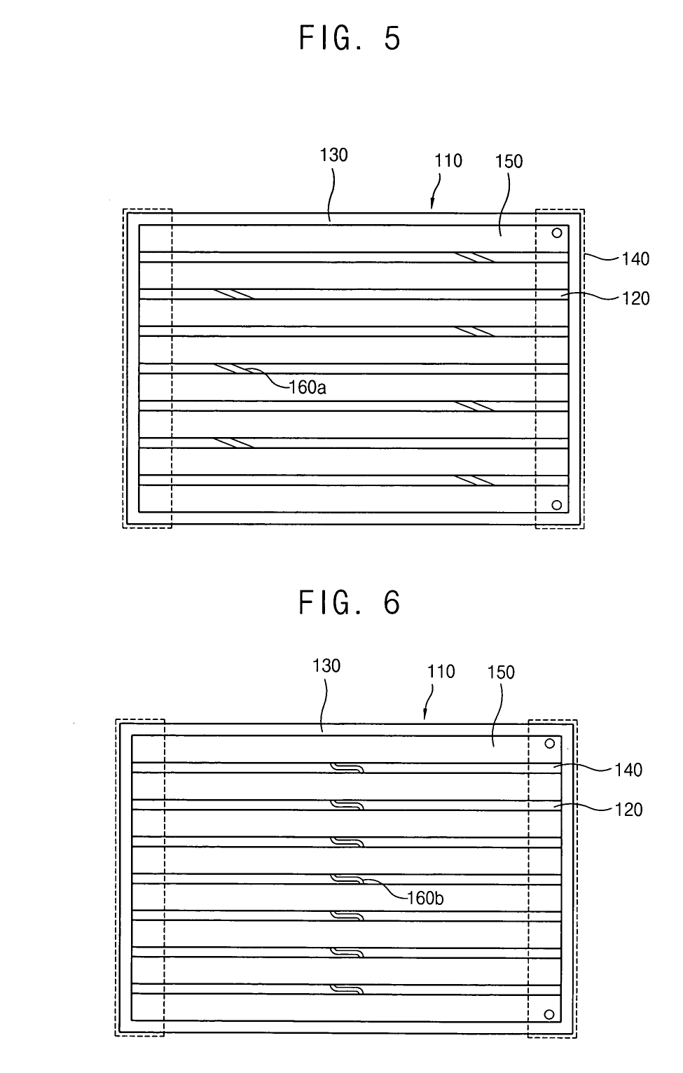

In the present embodiment, the gas passages 160 are formed through the central portions of the partition wall 120. Alternatively, as shown in FIG. 5, gas passages 160a may be formed in a zigzag pattern through the partition walls 120. Also, as shown in FIG. 6, gas passages 160b may have S shapes.

### Embodiment 2

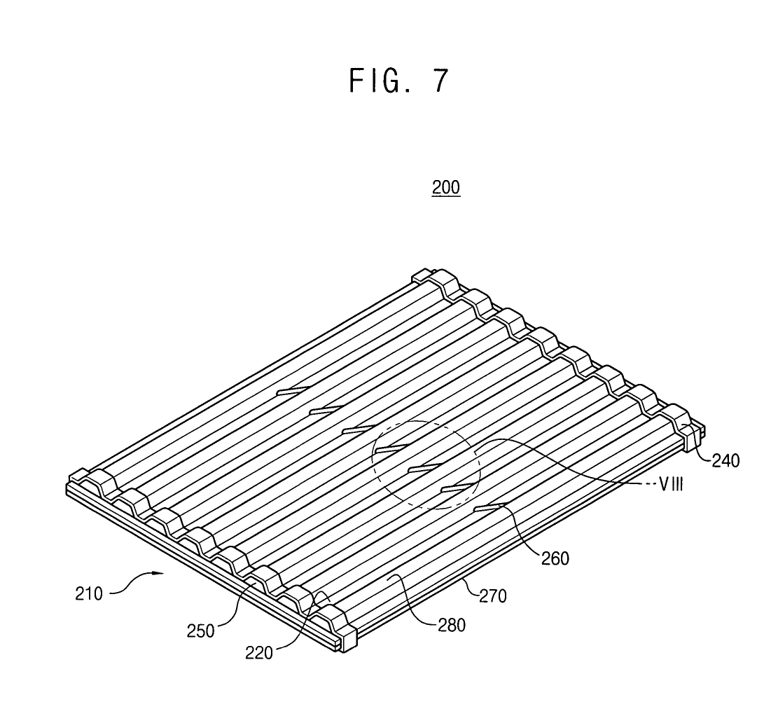

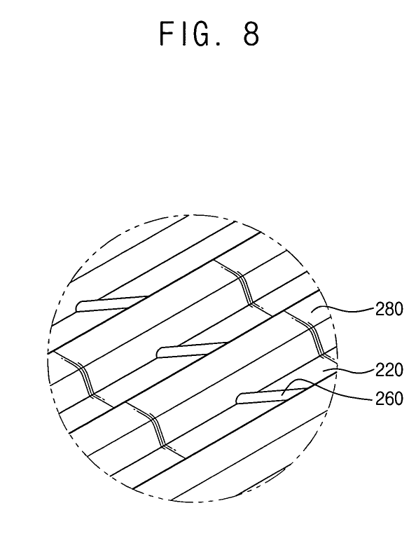

FIG. 7 is a perspective view illustrating a surface light source device in accordance with a second embodiment of the present invention. FIG. 8 is an enlarged perspective view illustrating a portion ‘VIII’ in FIG. 8.

Referring to FIGS. 7 and 8, a surface light source device 200 in accordance with a second embodiment of the present invention includes a body 210 having an inner space into which a discharge gas is injected, and an electrode 240 supplying a discharge voltage to the discharge gas.

The body 210 includes a first substrate 270, and a second substrate 280 disposed over the first substrate 270. Partition wall portions 220 that make contact with the upper face of the first substrate 270 are integrally formed with the second substrate 280 to form a plurality of discharge spaces 250 isolated from one another between the first and second substrates 270 and 280. Each of the discharge spaces 250 has substantially arcuate shapes. The electrode 240 is formed on an outer surface of the body 210.

Gas passages 260 are formed through central portion of the partition wall portions 220. The gas passages 260 may be formed by protruding the partition wall portions 220 from the second substrate 280. To form the gas passages 260, a pipe substantially having a semi-cylindrical shape is disposed on the first substrate 210. The partition wall portions 220 make contact with the pipe. When a radius of the pipe is smaller than a thickness of the partition wall portions 220, the gas passages 260 that are not protruded from the partition wall portions 220 may be formed. The gas passages 260 having a straight shape are inclined with respect to a length direction of the discharge spaces 250. Here, functions of the gas passages 260 are illustrated in Embodiment 1. Thus, any further illustrations with respect to the gas passages 260 are omitted herein.

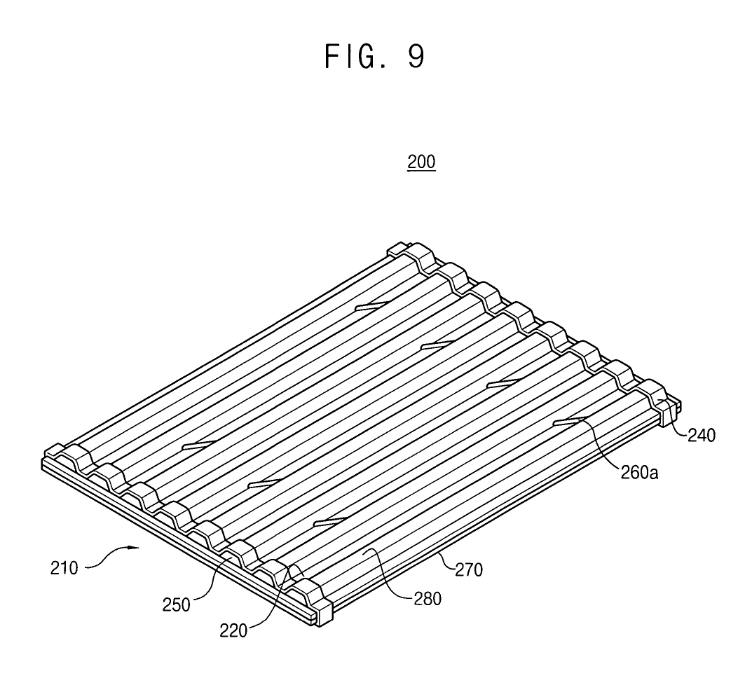

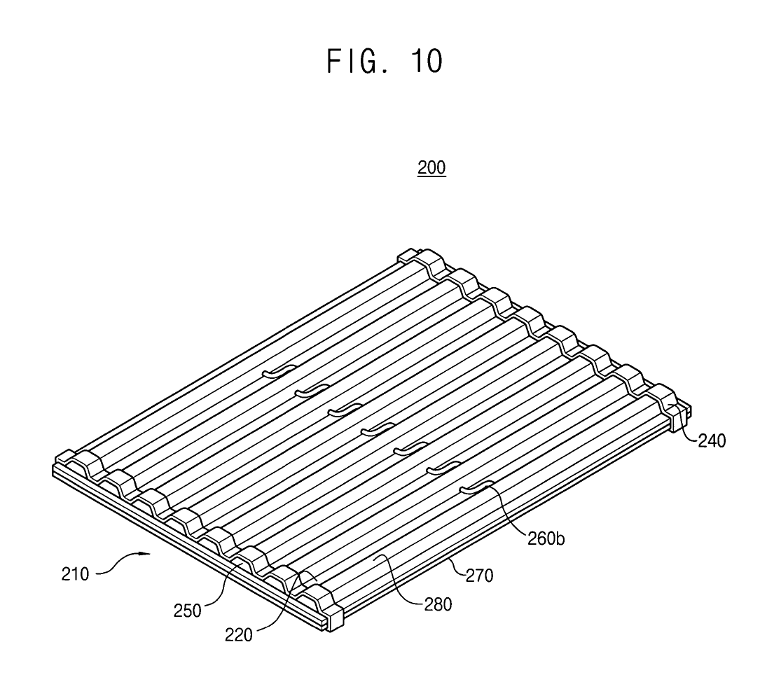

In the present embodiment, the gas passages 260 are formed through the central portions of the partition wall portions 220. Alternatively, as shown in FIG. 9, gas passages 260a may be irregularly formed in a zigzag pattern through the partition wall portions 220. Also, as shown in FIG. 10, gas passages 260b may have S shapes.

### Embodiment 3

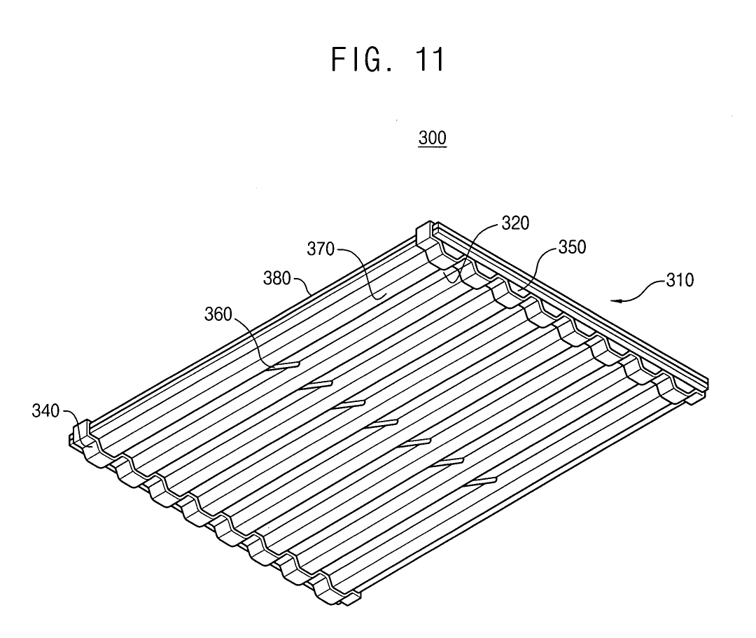

FIG. 11 is a perspective view illustrating a surface light source device in accordance with a third embodiment of the present invention.

Referring to FIG. 11, a surface light source device 300 in accordance with the third embodiment of the present invention includes a body 310 having an inner space into which a discharge gas is injected, and an electrode 340 supplying a discharge voltage to the discharge gas.

The body 310 includes a first substrate 370 having partition wall portions 320, and a second substrate 380 arrayed over the first substrate 370. The partition wall portions 320 make contact with the second substrate 380 to form a plurality of discharge spaces 350 that are isolated from each other. Gas passages 360 that are inclined by a predetermined angle with respect to a length direction of the discharge spaces 350 are formed through central portions of the partition wall portions 360. Thus, each of the discharge spaces 350 is connected to one another through the gas passages 360.

### Embodiment 4

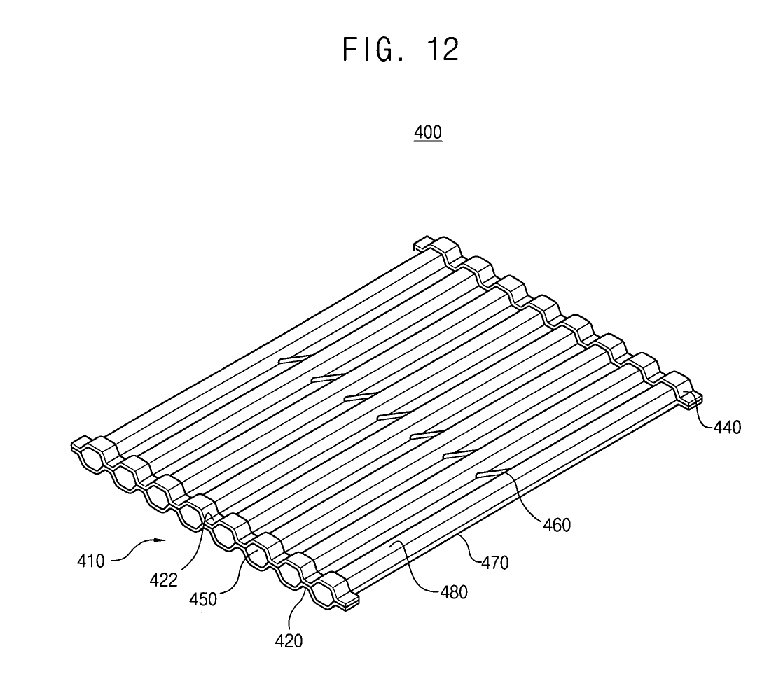

FIG. 12 is a perspective view illustrating a surface light source device in accordance with a four embodiment of the present invention.

Referring to FIG. 12, a surface light source device 400 in accordance with a fourth embodiment of the present invention includes a body 410 having an inner space into which a discharge gas is injected, and an electrode 440 supplying a discharge voltage to the discharge gas.

The body 410 includes a first substrate 470 with which first partition walls 420 are integrally formed, and a second substrate 480 with which second partition walls 422 are integrally formed. The second substrate 480 is placed over the first substrate 470. The first partition wall portions 420 make contact with the second partition wall portions 422 to form discharge spaces 350 isolated from each other. The first and second partition wall portions 420 and 422 have semi-cylindrical cross sections. Gas passages 460 that are inclined by a predetermined angle with respect to a length direction of the discharge spaces 450 are formed through the second partition wall portions 422. Thus, each of the discharge spaces 450 is connected to one another through the gas passages 460.

Alternatively, the gas passages 460 may be formed through the first partition wall portions 420. Also, two grooves may be formed in the first and second partition wall portions 420 and 422. The grooves may be integrally united with each other to form the gas passages 460.

According to the present embodiment, since the gas passages are inclined with respect to the length direction of the discharge spaces, the current may not rapidly flow into the adjacent discharge space. Thus, the current drift effect may be greatly suppressed so that the surface light source device may have improved luminance uniformity.

### Embodiment 5

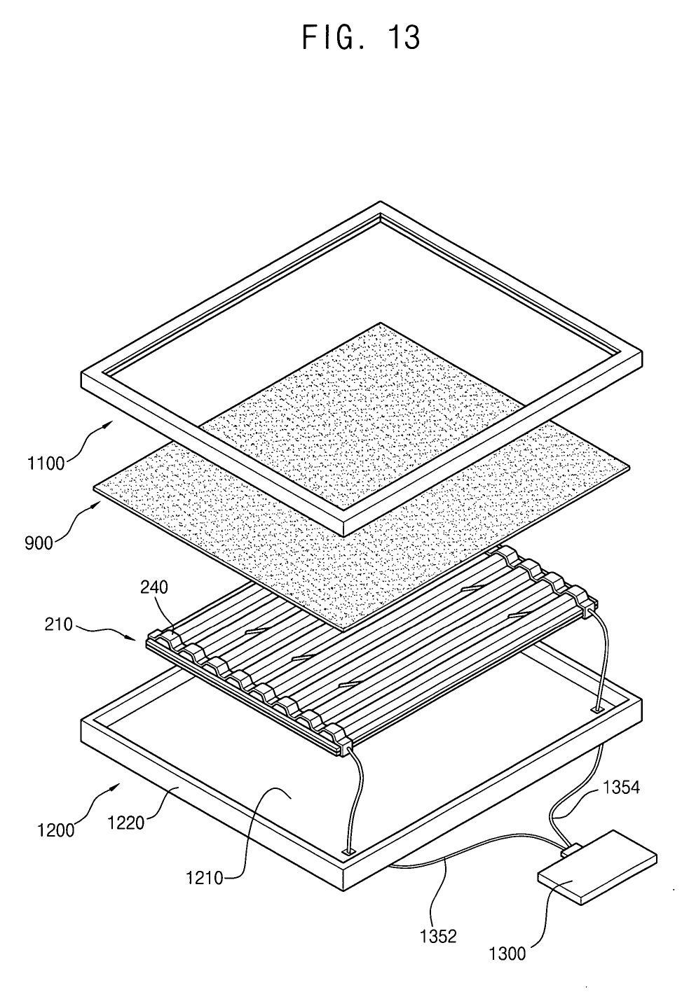

FIG. 13 is an exploded perspective view illustrating a back light unit having the surface light source device in accordance with a fourth embodiment of the present invention.

Referring to FIG. 13, a back light unit 1000 in accordance with the present embodiment includes the surface light source device 200 in FIG. 9, upper and lower cases 1100 and 1200, an optical sheet 900 and an inverter 1300.

The surface light source device 200 is illustrated in detail with reference to FIG. 9. Thus, any further illustrations of the surface light source device 200 are omitted. Also, other surface light source devices in accordance with Embodiments 1 and 4 may be employed in the back light unit 1000.

The lower case 1200 includes a bottom face 1210 for receiving the surface light source device 200, and a side face 1220 extending from an edge of the bottom face 1210. Thus, a receiving space for receiving the surface light source device 200 is formed in the lower case 1200.

The inverter 1300 is arranged under the lower case 1200. The inverter 1300 generates a discharge voltage for driving the surface light source device 200. The discharge voltage generated from the inverter 1300 is applied to the electrode 240 of the surface light source device 200 through first and second electrical cables 1352 and 1354.

The optical sheet 900 includes a diffusion sheet (not shown) for uniformly diffusing a light irradiated from the surface light source device 200, and a prism sheet (not shown) for providing straightforwardness to the light diffused by the diffusion sheet.

The upper case 1100 is combined with the lower case 1220 to support the surface light source device 200 and the optical sheet 900. The upper case 1100 prevents the surface light source device 200 from being separated from the lower case 1200.

Additionally, an LCD panel (not shown) for displaying an image may be arranged over the upper case 1100.

Having described the exemplary embodiments of the present invention and its advantages, it is noted that various changes, substitutions and alterations can be made herein without departing from the spirit and scope of the invention as defined by appended claims.

1. A surface light source device, comprising:
a body including a plurality of partition walls that divide an inner space into which a discharge gas is injected into a plurality of discharge spaces isolated from each other, and gas passages through which the discharge gas passes formed through the partition walls, the gas passages being arranged in an inclined direction with respect to a lengthwise direction of the discharge spaces; and
an electrode provided to the body so as to supply a discharge voltage to the discharge gas.

2. The surface light source device of claim 1, wherein the gas passages have a straight shape or an S-shape.

3. The surface light source device of claim 1, wherein the gas passages are positioned at central portions of the partition walls.

4. The surface light source device of claim 1, wherein the gas passages are arranged in a zigzag pattern.

5. The surface light source device of claim 1, wherein the gas passages have semi-cylindrical cross sections.

6. The surface light source device of claim 1, wherein the body comprises:
a first substrate;
a second substrate placed over the first substrate; and
a sealing member interposed between edges of the first and second substrates, the sealing member defining the inner space of the body.

7. The surface light source device of claim 1, wherein the body comprises:
a first substrate; and
a second substrate placed over the first substrate, the second substrate having partition walls that are integrally formed with the second substrate, the partition walls making contact with the the first substrate.

8. The surface light source device of claim 1, wherein the body comprises:
a first substrate having partition walls that are integrally formed with the first substrate; and
a second substrate placed over the the first substrate, the partition walls making contact with the second substrate.

9. The surface light source device of claim 1, wherein the body comprises:
a first substrate having first partition wall portions that are integrally formed with the first substrate;
a second substrate placed over the first substrate, the second substrate having second partition walls that are integrally formed with the second substrate and make contact with the first partition wall portions.

10. The surface light source device of claim 1, wherein the electrode is arranged in a direction substantially perpendicular to the lengthwise direction of the discharge spaces.

11. The surface light source device of claim 1, wherein each of the partition walls has a width of about 1 mm to about 5 mm.

12. A surface light source device, comprising:
a body including a plurality of partition walls that divide an inner space into which a discharge gas is injected into a plurality of discharge spaces isolated from each other, and gas passages connecting adjacent two discharge spaces, the gas passages having lengths longer than widths of the partition walls; and
an electrode provided to the body so as to supply a discharge voltage to the discharge gas.

13. The surface light source device of claim 12, wherein the gas passages have a straight shape or an S-shape.

14. The surface light source device of claim 12, wherein the gas passages are arranged in a zigzag pattern.

15. The surface light source device of claim 12, wherein the gas passages have semi-cylindrical cross sections.

16. The surface light source device of claim 12, wherein each of the partition walls has a width of about 1 mm to about 5 mm.

17. A back light unit comprising:
a surface light source device including a body including a plurality of partition walls that divide an inner space into which a discharge gas is injected into a plurality of discharge spaces isolated from each other, and gas passages through which the discharge gas passes formed through the partition walls, the gas passages being arranged in an inclined direction with respect to a lengthwise direction of the discharge spaces, and an electrode provided to the body so as to supply a discharge voltage to the discharge gas;
a case for receiving the surface light source device;
an optical sheet interposed between the surface light source device and the case; and
an inverter for applying a discharge voltage to the electrode of the surface light source device.

18. The unit of claim 17, wherein the gas passages have a straight shape or an S-shape.

19. The unit of claim 17, wherein the gas passages are arranged in a zigzag pattern.
